(19) United States
(12) Patent Application Publication
(10) Pub. No.: US 2023/0376967 A1
(43) Pub. Date: Nov. 23, 2023

(54) VEHICLE AND MOBILE DEVICE COMMUNICATING WITH VEHICLE

(71) Applicants: HYUNDAI MOTOR COMPANY, Seoul (KR); KIA CORPORATION, Seoul (KR)

(72) Inventor: Yongseok Jeong, Yongin-si (KR)

(21) Appl. No.: 18/112,651

(22) Filed: Feb. 22, 2023

(30) Foreign Application Priority Data
May 19, 2022 (KR) 10-2022-0061155

(51) Int. Cl. G06Q 20/40; G06Q 20/32; B60K 35/00

(52) U.S. Cl. CPC G06Q 20/407; G06Q 20/3223; G06Q 20/3224; G06Q 20/4012; G06Q 20/4015; G06Q 20/3278; B60K 35/00; G06Q 2220/00; B60K 2370/161; B60K 2370/563; B60K 2370/589

(57) ABSTRACT

A vehicle for performing a simple payment service, and a mobile device configured to perform communication with the vehicle includes a display, a communicator configured to perform communication with a mobile device, and a processor configured to transmit an authentication request signal to the mobile device when performing a car payment service, proceed with a payment when receiving authentication success information from the mobile device, and control the display to output authentication failure information and cancel the payment when the authentication failure information is received from the mobile device.

### CROSS REFERENCE TO RELATED APPLICATIONS

This application claims the benefit of Korean Patent Application No. 10-2022-0061155, filed on May 19, 2022 in the Korean Intellectual Property Office, the disclosure of which is incorporated herein by reference.

### BACKGROUND

### 1. Field

Embodiments of the present disclosure relate to a vehicle for paying for goods purchased by a user or services used by the user, and a mobile device communicating with the vehicle.

### 2. Description of the Related Art

As communication techniques have advanced, vehicles have been able to perform two-way communication with a remote controller. Therefore, when the remote controller is positioned close to the vehicle even when a driver does not perform a separate manual operation, a door of the vehicle is automatically unlocked so that the driver may open the door or a trunk. In addition, the vehicle may be automatically started when a start button is operated by the driver even when a key is not used.

In recent years, the door or start of the vehicle may be controlled using a mobile device. In addition, it is possible to automatically pay for parking in a parking lot or automatically pay for gas at a gas station using a simple payment service (also referred to as a “smart pay service” or a “car pay service”).

As described above, by using the simple payment service in the vehicle, the driver needs to input a password or the like through a terminal provided inside the vehicle for user authentication. In this case, there is a problem in that the password may be exposed to others.

In addition, since the user authentication is performed by inputting the password, there is a limitation in determining whether the user who has currently input the password is a registered user, and there is a problem in that payment is misused by others when the vehicle is stolen.

### SUMMARY

Therefore, it is an aspect of the present disclosure to provide a vehicle which allows user authentication to be performed on a mobile device when payment is performed using a pre-registered car pay service and completes payment or controls an output of payment failure information in response to whether the authentication has succeeded.

It is another aspect of the present disclosure to provide a mobile device which sets payment setting information for using a car pay service, performs user authentication in response to a payment request of a vehicle, and determines whether payment is available based on whether the authentication has succeeded and the set payment setting information.

Additional aspects of the disclosure will be set forth in part in the description which follows and, in part, will be obvious from the description, or may be learned by practice of the disclosure.

In accordance with one aspect of the present disclosure, a vehicle includes a display, a communicator configured to perform communication with a mobile device, and a processor configured to transmit an authentication request signal to the mobile device when performing a car payment service, proceed with a payment when authentication success information is received from the mobile device, and control the display to output authentication failure information and cancel the payment when the authentication failure information is received from the mobile device.

The mobile device configured to perform communication with the vehicle according to one aspect may perform a digital key service for controlling an operation of at least one of a plurality of electronic devices provided in the vehicle. The processor of the vehicle according to one aspect may control interlocking with the digital key service when performing the car payment service.

The processor of the vehicle according to one aspect may determine whether the mobile device configured to perform the digital key service is present in the vehicle before transmitting the authentication request signal.

The vehicle according to one aspect may further include an input device. When it is determined that the mobile device configured to perform the digital key service is not present in the vehicle, the processor of the vehicle according to one aspect may control the display to display an image for inputting a password or a pattern, perform the user authentication based on the password or the pattern received through the input device, and proceed with the payment when the user authentication is successful.

The processor of the vehicle according to one aspect may determine whether to subscribe to the car payment service through the mobile device before transmitting the authentication request signal.

The vehicle according to one aspect may further include an input device. When the authentication failure information is received from the mobile device, the processor of the vehicle according to one aspect may control the display to display an image for inputting a password or a pattern, perform user authentication based on the password or the pattern received through the input device, and proceed with the payment when the user authentication is successful.

The processor of the vehicle according to one aspect may control execution of the car payment service when a current position is a predetermined position.

The vehicle according to one aspect may further include an input device. When the authentication failure information is received from the mobile device, the processor of the vehicle according to one aspect may control the display to display an image for inputting a password or a pattern, perform user authentication based on the password or the pattern received through the input device, and proceed with the payment when the user authentication is successful.

When non-payment information is received from the mobile device, the processor of the vehicle according to one aspect may control the display to display the received non-payment information.

The communicator of the vehicle according to one aspect may support at least one of Bluetooth communication, ultra-wide band communication, near-field communication (NFC), low-frequency communication, and high-frequency communication.

In accordance with another aspect of the present disclosure, a mobile device includes a display, an information input device configured to receive user authentication information, a memory configured to store pre-registered user authentication information, a communicator configured to perform communication with a vehicle, and a processor configured to control the display to display guide information requesting user authentication when an authentication request signal is received from the vehicle, perform the user authentication based on the user authentication information received through the information input device and the pre-registered user authentication information, and transmit authentication success information or authentication failure information corresponding to a result of the user authentication to the vehicle.

The processor of the mobile device according to another aspect may control execution of a car payment service in response to the receiving of the authentication request signal and transmit the authentication success information or the authentication failure information to the vehicle during the execution of the car payment service.

The processor of the mobile device according to another aspect may control the display to output guide information requesting an input of payment setting information to be used for the car payment service when a subscription command of the car payment service is received through the input device and store information received through the input device as the payment setting information of the car payment service.

The set payment setting information of the car payment service may include at least one of card information and account information and may further include a maximum payment amount per day, a maximum payment amount per transaction, and a maximum number of transactions per day.

When a result of the user authentication is authentication success, the processor of the mobile device according to another aspect may determine whether payment is available based on payment request information received from the vehicle and the set payment setting information of the car payment service and transmit the authentication success information and payment availability information to the vehicle when it is determined that the payment is available.

The processor of the mobile device according to another aspect may transmit non-payment information to the vehicle when it is determined that the payment is not available.

The processor of the mobile device according to another aspect may transmit information on a remaining payment amount and a remaining number of payments to the vehicle when it is determined that the payment is available.

The processor of the mobile device according to another aspect may control subscription information of the car payment service, which corresponds to whether to subscribe to the car payment service, to be transmitted to the vehicle when subscription inquiry information of the car payment service is received from the vehicle.

The processor of the mobile device according to another aspect may perform a digital key service for controlling an operation of at least one of a plurality of electronic devices provided in the vehicle and controls interlocking with the digital key service when performing the car payment service.

The processor of the mobile device according to another aspect may perform the user authentication based on password information or pattern information received through the information input device and pre-registered password information or pattern information.

The processor of the mobile device according to another aspect may control the display to display identification information of another mobile device when request information of the car payment service is received from another mobile device and transmit approval information, payment information, and a digital key of the car payment service to another mobile device when an approval command is received through the information input device.

The processor of the mobile device according to another aspect may share the car payment service when a digital key is received from another mobile device.

The processor of the mobile device according to another aspect may perform the same function as that of the received digital key when the digital key is received from another mobile device.

### BRIEF DESCRIPTION OF THE FIGURES

These and/or other aspects of the disclosure will become apparent and more readily appreciated from the following description of the embodiments, taken in conjunction with the accompanying drawings of which:

FIG. 1 is a control configuration diagram of a vehicle according to one embodiment;

FIG. 2 is a detailed configuration diagram of a processor and a communicator of a vehicle according to one embodiment;

FIG. 3 is a control flowchart of a vehicle according to one embodiment;

FIG. 4A is an exemplary view of guide information displayed on a first display when a car pay service is performed in a vehicle according to one embodiment;

FIG. 4B is an exemplary view of guide information displayed on the first display when the car pay service is performed in the vehicle according to one embodiment;

FIG. 4C is an exemplary view of guide information displayed on the first display when the car pay service is performed in the vehicle according to one embodiment;

FIG. 5A is an exemplary view of guide information displayed on the first display when the car pay service is performed in the vehicle according to one embodiment;

FIG. 5B is an exemplary view of guide information displayed on the first display when the car pay service is performed in the vehicle according to one embodiment;

FIG. 5C is an exemplary view of guide information displayed on the first display when the car pay service is performed in the vehicle according to one embodiment;

FIG. 6 is a control configuration diagram of a mobile device communicating with a vehicle according to one embodiment;

FIG. 7A is an exemplary view of guide information displayed on a second display when payment setting information of the car pay service is set in a mobile device according to one embodiment;

FIG. 7B is an exemplary view of guide information displayed on the second display when the payment setting information of the car pay service is set in the mobile device according to one embodiment;

FIG. 7C is an exemplary view of guide information displayed on the second display when the payment setting information of the car pay service is set in the mobile device according to one embodiment;

FIG. 7D is an exemplary view of guide information displayed on the second display when the payment setting information of the car pay service is set in the mobile device according to one embodiment;

FIG. 8 is a control flowchart of the mobile device according to one embodiment;

FIG. 9A is an exemplary view of guide information displayed on the second display when the car pay service is performed in the mobile device according to one embodiment;

FIG. 9B is an exemplary view of guide information displayed on the second display when the car pay service is performed in the mobile device according to one embodiment;

FIG. 9C is an exemplary view of guide information displayed on the second display when the car pay service is performed in the mobile device according to one embodiment;

FIG. 9D is an exemplary view of guide information displayed on the second display when the car pay service is performed in the mobile device according to one embodiment; and

FIG. 10 is a detailed configuration diagram of a processor and a communicator of a vehicle according to another embodiment.

### DETAILED DESCRIPTION

The same reference numerals refer to the same components throughout the specification. The specification does not describe all elements of the embodiments, and general contents in the art to which the present disclosure pertains or overlapping contents among the embodiments will be omitted. Terms “unit, module, member, and device” used in the specification may be implemented in software or hardware, and according to the embodiments, a plurality of “units, modules, members, and devices” may be implemented as one component or one “unit, module, member, and device” may also include a plurality of components.

Throughout the specification, when a certain portion is described as being “connected” to another portion, it includes not only a case in which the certain portion is directly connected to another portion but also a case in which it is indirectly connected thereto, and the indirect connection includes a connection through a wireless communication network.

In addition, when a certain portion is described as “including” a certain component, it means that other components may be further included, rather than excluding the other components unless otherwise stated.

Terms such as first and second are used to distinguish one component from another, and the components are not limited by the above-described terms.

The singular expression includes the plural expression unless the context clearly dictates otherwise.

In each operation, identification signs are used for convenience of description, and the identification signs do not describe the order of each operation, and each operation may be performed differently from the specified order unless the context clearly states the specific order.

Hereinafter, an operating principle and embodiments of the present disclosure will be described with reference to the accompanying drawings.

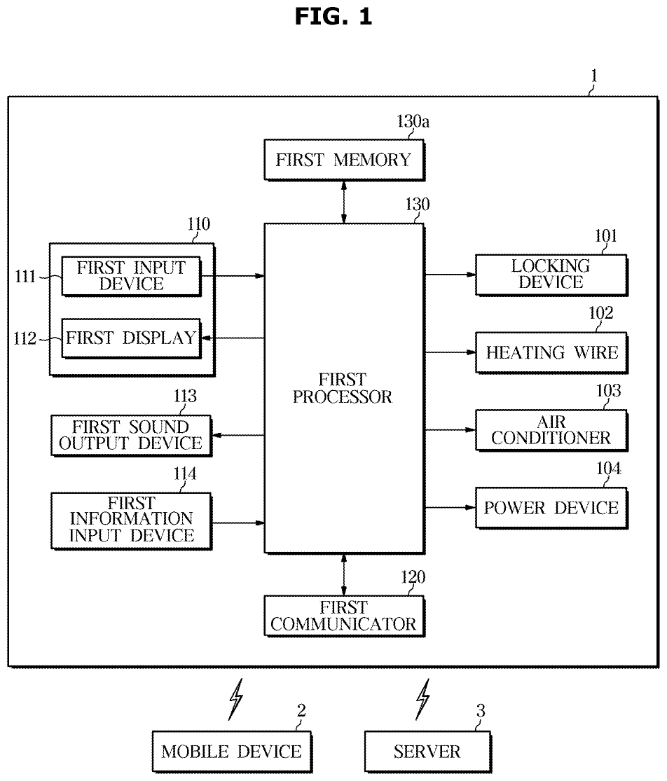

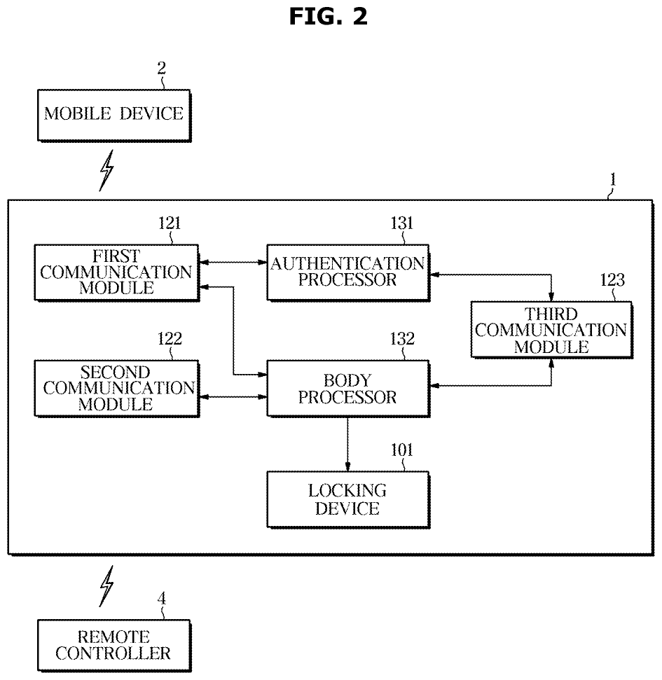

FIG. 1 is a control configuration diagram of a vehicle according to one embodiment and will be described with reference to FIG. 2. FIG. 2 is a detailed configuration diagram of a processor and a communicator of a vehicle according to one embodiment.

First, before describing a control configuration of the vehicle performing a car pay service and a digital key service, external devices communicating with the vehicle for performing the car pay service and the digital key service will be described.

As shown in FIG. 1, a vehicle 1 may communicate with at least one mobile device 2 and a server 3 and also communicate with a remote controller 4 (see FIG. 2).

The vehicle in the embodiment may be any one of an internal combustion engine vehicle and an eco-friendly vehicle.

The vehicle 1 may be controlled by at least one mobile device 2 and at least one remote controller 4. The vehicle 1 may be controlled by a digital key registered in the mobile device 2. The vehicle 1 may also perform a car pay service through the communication with the server 3.

The mobile device 2 (also referred to as a “user terminal”) may proceed with the subscription of the digital key service for user registration of a user who uses the vehicle through an application. At this time, the mobile device 2 may receive and store a digital key (or an electronic key) of the vehicle from the server. Here, the digital key may include identification information of the mobile device, authentication information of the mobile device, and control right information of the vehicle.

The mobile device 2 may transmit the stored digital key to the vehicle in response to completion of subscription of the digital key service.

The application may be an application related to the digital key service.

For example, the mobile device 2 may change a door of the vehicle to enter a locked state or an unlocked state by remotely controlling a state of a locking device of the vehicle using the digital key, control operations of various electronic devices provided in the vehicle using the digital key, and control the start of the vehicle 1.

This mobile device 2 may receive a user input for vehicle control and display operation information of the vehicle.

For example, the mobile device 2 may receive at least one of a door lock and unlock command, a tailgate lock and unlock command, a lamp turn-on command, and a lamp turn-off command as the user input.

The mobile device 2 may display door lock completion or failure information corresponding to the door lock command, display door unlock completion or failure information corresponding to the door unlock command, display lamp turn-on completion or lamp turn-on failure information in response to a turn-on command transmitted to the vehicle, or display the remaining time until the lamp is turned off.

The mobile device 2 may attempt a communication connection with the vehicle 1 in response to an execution command of the digital key service of the vehicle. At this time, the mobile device 2 may transmit the digital key to the vehicle. The digital key may include the identification information of the mobile device 2, the authentication information of the mobile device, and the vehicle control right information, and may further include a vehicle identification information.

The mobile device 2 in the embodiment may communicate with the vehicle through at least one of a Bluetooth low energy (BLE) module, an ultra-wide band (UWB) communication module, and a near field communication (NFC) module.

The mobile device 2 may include an application (i.e., an app) for performing the digital key service of the vehicle. The mobile device 2 may perform the car pay service. At this time, the mobile device 2 may link the digital key service with the car pay service. An application for the digital key service may also perform the car pay service.

The mobile device 2 may also be a main mobile device of a first user or may also be an auxiliary mobile device of the first user.

The mobile device 2 may also be a mobile device of the first user or may also be a mobile device of a second user.

The first user may correspond to owner of the vehicle, and the second user may be a sharer who uses the vehicle under approval for the control right of the vehicle from the first user.

The mobile device of the second user may request the sharing of the digital key and request the right to use the car pay service from the mobile device of the first user, the vehicle, or the server.

The mobile device of the second user may receive the digital key from the mobile device of the first user and store the received digital key.

The received digital key may include one function or two or more functions among a plurality of functions for controlling the vehicle.

For example, when only start ON-OFF functions among the digital key functions is selected and received from the mobile device of the first user, the mobile device of the second user may control only the start ON or start OFF using the received digital key.

When receiving the digital key from the mobile device of the first user, the mobile device of the second user may use a car payment service (i.e., the car pay service). The mobile device of the second user may share the car payment service with the mobile device of the first user in response to the receiving the digital key.

At this time, the mobile device of the second user may use the car payment service based on information set in the mobile device of the first user.

The mobile device of the second user may also receive approval information for the right to use the car pay service and setting information of the car pay service from the mobile device of the first user and use the car pay service according to the received approval information and payment setting information of the car pay service.

The digital key stored in the mobile device of the first user is also referred to as an owner key.

The digital key stored in the mobile device of the second user is also referred to as a shared key.

The mobile device 2 may be implemented as a computer or a portable terminal which may access the vehicle through a network.

Here, the computer may include, for example, a notebook personal computer (PC), a desktop PC, a laptop PC, a tablet PC, a slate PC, or the like, which is equipped with a web browser, and the portable terminal is a wireless communication device with guaranteed portability and mobility and may include any kind of a handheld based wireless communication device such as a personal communication system (PCS), global system for mobile communication (GSM), a personal digital cellular (PDC), a personal handyphone system (PHS), a personal digital assistant (PDA), international mobile telecommunication (IMT)-2000, code division multiple access (CDMA)-2000, W-CDMA, a wireless broadband Internet (WiBro) terminal, or a smart phone, or a wearable device such as a watch, a ring, a bracelet, a anklet, a necklace, glasses, a contact lens, or a head-mounted-device (HMD).

The server 3 communicates with the vehicle 1 and the at least one mobile device 2. The server 3 may store the user identification information who uses the vehicle 1, the vehicle identification information and the identification information of the mobile device.

The user identification information, the identification information of the at least one mobile device 2, and the vehicle identification information, which are stored in the server 3 may be information registered through the application (app) installed in the vehicle terminal or the mobile device 2.

The identification information of the vehicle 1 may include a vehicle type, model, identification information (license plate), power generation method (e.g., hybrid electric, electric, internal combustion engine, or hydrogen), transmission type, and the like of the vehicle.

The server 3 may allow the user to control various electronic devices of the vehicle 1 through the mobile device 2 based on the digital key information received through the mobile device 2.

The server 3 may allow the payment by the car pay service to proceed based on authentication success information and payment setting information received from the mobile device 2.

The server 3 may allow the payment by the car pay service to proceed based on authentication success information and payment setting information received from the vehicle 1.

The server 3 may be any one of a card company's server, a simple payment service (e.g., a smart pay service) providing server, a vehicle manufacturer server, a digital key service providing server, a vehicle management server, and a vehicle auto shop server.

Hereinafter, a configuration of the vehicle performing the digital key service and the car pay service will be described in detail.

The vehicle 1 includes a body having an interior and an exterior and a chassis in which mechanical devices required for traveling are installed as the remaining portions except for the body. The exterior of the body may include front, rear, left and right doors and a tailgate provided on the rear of the body. The door and the tailgate are provided with a handle which may be held by a user, and the handle is provided with an operation member configured to receive a user's opening and closing command. The operation member may be provided in various types, such as a switch type, a button type, a touch type, and a lever type.

The door and the tailgate may be provided with a locking device 101 configured to perform lock and unlock.

The vehicle may further include a side mirror configured to provide the driver with a rear view of the vehicle 1 and a mirror adjustment member (not shown) configured to fold or unfold the side mirror.

The interior of the body includes a seat in which a rider sits, a dashboard, and a head unit configured to receive a user input and display operation information of at least one electronic device.

Here, the seat may be classified into a driver seat, a passenger seat, and a rear seat according to the arrangement. Each seat may be provided with a seat adjustment member (not shown) which may adjust a distance and height from the dashboard and an angle of a backrest with respect to the dashboard. Each seat may be provided with at least one of a heating wire 102 and a ventilation device.

The vehicle may be provided with an air conditioner 103 configured to discharge hot air or cold air in order to adjust a temperature of indoor air to a target temperature.

The chassis of the vehicle is a frame configured to support the body and may include a power device 104, a braking device, and a steering device configured to apply a driving force, a braking force, and a steering force to front, rear, left, and right wheels and further include a suspension device, a transmission device, and the like.

The power device 104 may initiate an operation in response to the start ON command and generate power in response to the operation.

The vehicle 1 may include a first input device 111 configured to receive the user input and a first display 112 configured to display information on functions being performed in the vehicle, display operation information of various functions which may be performed in the vehicle, and display information corresponding to the user input.

The first input device 111 may receive the user input, for example, the start ON command, a start OFF command, a tailgate opening and closing command, a tailgate lock command, a tailgate unlock command, an opening and closing command of at least one door, a lock command of the at least one door, and an unlock command of the at least one door.

The first input device 111 may receive ON/OFF commands of at least one of a radio mode, a broadcasting mode, a phone call mode, a Bluetooth mode, an audio mode, a video mode, and a navigation mode and receive destination information in response to the navigation mode.

The first input device 111 may receive position information of the side mirror for each user, receive position information of the seat for each user, and receive the user identification information.

The first input device 111 may receive an operation command and operation information of at least one electronic device provided in the vehicle.

The first input device 111 may receive a user registration command for registering the vehicle user and receive a user deletion command for deleting some of the registered users.

The first input device 111 may receive the user registration command for the car pay service and receive the user deletion command for deleting some of the registered users.

The first input device 111 may receive subscription information for user registration of the car pay service such as user identification information, card information, account information, and identification information of at least one mobile device.

The user identification information may include at least one of a user name, a user's date of birth, a user's social security number, a user's gender, a user's phone number, a user's home address, a user's company address, a user's driver's license information, and a user's email address.

The card information may include at least one of a card company, a card number, a card expiration date, a card password, and a security code (e.g., CVC).

The identification information of the mobile device is a unique identification information of the mobile device and includes at least one of a phone number of the mobile device, a Wi-Fi MAC address of the mobile device, a serial number of the mobile device, and an International mobile equipment identity (IMEI).

The identification information of the mobile device 2 may be a Bluetooth identification information (BTID).

The first input device 111 may receive a password for the user authentication using the car pay service.

The first input device 111 may receive any one of a manual payment mode and an automatic payment mode when the car pay service and the digital key are linked.

The manual payment mode is a mode in which the user performs the user authentication using the mobile device when performing the payment through the car pay service.

The automatic payment mode is a mode in which the user authentication is automatically performed by performing the encrypted communication between the vehicle, the mobile device, and the remote controller without user action when the payment is made through the car pay service.

The first input device 111 may receive the identification information of the mobile device requesting the sharing of the car pay service and receive an approval or cancellation command of the sharing. The first input device 111 may further include a start button configured to receive the start ON command and the start OFF command.

The first input device 111 may include a hardware device, such as various buttons or switches, a pedal, a keyboard, a mouse, a track-ball, various levers, a handle, or a stick.

The first input device 111 may also be provided on at least one of a center fascia and the head unit of the vehicle. The first input device provided on the center fascia and the head unit may be provided in at least one of a jog dial type, a button type, and a touch pad type.

The first input device 111 may also include a graphical user interface (GUI), such as a touch pad, that is, a software device. The touch pad is implemented as a touch screen panel (TSP) to form a layered structure with a display panel of the first display 112.

The first display 112 may display navigation information corresponding to a navigation mode and display current position information. The first display 112 may display a subscription image for user registration of the car pay service. The first display 112 may display a progress image of the car pay service in response to the execution of the car pay service and display payment completion information and payment failure information as images.

The first display 112 may display the identification information of the mobile device requesting the sharing of the car pay service and display the approval information of the car pay service for approval completion or approval rejection. Here, the first display 112 and the first input device 111 may be a display and an input device of a vehicle terminal 110.

The vehicle terminal 110 is an audio/video/navigation (AVN) device configured to perform audio, video, and navigation modes and may be mounted on the dashboard of the vehicle in an embedded or detachable type.

A first sound output device 113 may output information of various functions performed in the vehicle 1 as a sound. For example, the first sound output device 113 may output the navigation information as a sound in response to the navigation mode.

The first sound output device 113 may output the progress information of the car pay service as a sound in response to the execution of the car pay service and output the payment completion information and the payment failure information as a sound.

The first sound output device 113 may output the progress information of the car pay service, the payment completion information, and the payment failure information by voice.

A first information input device 114 may receive information for user recognition. Here, the information for user recognition may include at least one of fingerprint information, facial image information, vein information, voice information, and iris information.

The first information input device 114 may include a microphone configured to receive the user's voice, and a charge-coupled device (CCD), a complementary metal-oxide semiconductor (CMOS) image sensor, or an infrared camera configured to acquire an image of the user's face or eyes.

The first information input device 114 may include any one of a CCD camera and a CCD scanner configured to acquire the fingerprint information, and include any one of a capacitive fingerprint sensor configured to detect a difference in capacitance according to a curvature of a fingerprint, an optical fingerprint sensor configured to detect the curvature of the fingerprint according to the shadow of reflected light, and an ultrasonic fingerprint sensor configured to detect minute features of a skin epidermal layer.

The first information input device 114 may include an infrared camera configured to acquire the vein information. Here, the infrared camera may use infrared rays close to visible rays.

The information for user recognition may further include at least one of pattern information and password information. In this case, the information for user recognition may be received through the first input device 111.

A first communicator 120 may include one or more components configured to enable the communication between an external device and an internal component of the vehicle 1 and include, for example, at least one of a short-range communication module, a wired communication module, and a wireless communication module. Here, the external device includes at least one mobile device 2, the server 3, and the remote controller 4.

The short-range communication module may include any short-range communication module configured to transmit and receive signals using a wireless communication network in a short range, such as a Bluetooth module, an infrared communication module, a radio frequency identification (RFID) communication module, a wireless local access network (WLAN) communication module, a near field communication (NFC) module, a ZigBee communication module, or a communication module.

The wired communication module may include not only any wired communication module such as a controller area network (CAN) communication module, a local area network (LAN) module, a wide area network (WAN) module, and a value added network (VAN) module, but also any cable communication module such as a universal serial bus (USB), a high definition multimedia interface (HDMI), a digital visual interface (DVI), recommended standard 232 (RS-232), power line communication, or a plain old telephone service (POTS). The wired communication module may further include a local interconnect network (LIN).

In addition to the Wi-Fi module and the wireless broadband module, the wireless communication module may include wireless communication modules configured to support various wireless communication methods, such as global system for mobile communication (GSM), code division multiple access (CDMA), wideband code division multiple access (WCDMA), universal mobile telecommunications system (UMTS), time division multiple access (TDMA), long term evolution (LTE), UWB modules, etc.

The first communicator 120 may communicate with an external device using different modules according to external devices communicating with the vehicle 1.

For example, as shown in FIG. 2, the first communicator 120 of the vehicle may communicate with the mobile device 2 using a first communication module 121. The first communication module 121 may include any one or two or more of a BLU module, a UWB module, and an NFC module.

When the UWB module is provided in the first communication module 121, the first communicator 120 may include a plurality of UWB antennas.

When the Bluetooth module is provided in the first communication module 121, the first communicator 120 may include a Bluetooth antenna.

When the near field communication (NFC) module is provided in the first communication module 121, the first communicator 120 may include an NFC antenna.

For another example, the first communicator 120 of the vehicle 1 may communicate with the remote controller 4 using a second communication module 122. The second communication module 122 may include at least one of a low-frequency communication module and a high-frequency communication module.

The low-frequency communication module may be a communication module configured to transmit and receive a low-frequency (LF) signal, and the high frequency communication module may be a communication module configured to receive a radio frequency (RF) signal transmitted from the remote controller 4. The remote controller 4 may perform two-way communication with the vehicle 1.

The remote controller 4 automatically communicates with the vehicle through at least one antenna among a plurality of antennas provided in the vehicle and transmits a remote key authentication signal for automatically communication with the vehicle 1 through at least one antenna when receiving a signal from the vehicle 1.

Here, the remote key authentication signal of the remote controller is a signal for authenticating the remote controller 4 and may include a signal for the identification information of the remote controller 4 and a intensity signal corresponding to an intensity of the received signal of the antenna of the remote controller 4.

In addition to the remote key authentication signal, the remote controller 4 may further transmit at least one of a door unlock control signal, a start ON control signal, a light turn-on control signal, and a folding control signal of the side mirror.

In still another example, the first communicator 120 may include a third communication module 123 configured to enable the communication between the components inside the vehicle. For example, the third communication module 123 may include a CAN communication module.

A first processor 130 may control the start of the vehicle in response to the start ON command inputted by the first input device 111 and control the turn-off of the vehicle in response to the start OFF command inputted by the first input device 111.

The first processor 130 may control the operation of at least one electronic device in response to the operation command of the at least one electronic device input by the first input device 111.

The first processor 130 may control the execution of the navigation mode in response to an operation command of the navigation mode input by the first input device 111. In this case, the first processor 130 may search for a route from a current position to a destination based on the destination information input to the first input device and the current position information received by a position receiver (not shown), generate the navigation information based on the searched route, and control an output of the generated navigation information.

The control of the output of the navigation information may include controlling at least one of the first display and the first sound output device to output the navigation information.

The first processor 130 may control the start of the vehicle in response to the start ON command of the remote controller 4 received from the first communicator 120 and control the turn-off of the vehicle in response to the start OFF command of the remote controller 4 received in the first communicator 120.

The first processor 130 may unlock the door in response to a unlock command of the remote controller 4 received in the first communicator 120 and control the lock of the door in response to a lock command of the remote controller 4 received in the first communicator 120.

As shown in FIG. 2, the first processor 130 may include an authentication processor 131 for user authentication and a body processor 132 configured to control at least one electronic device provided in the vehicle.

The body processor 132 of the first processor 130 may perform communication through the remote controller 4 and the second communication module 122. At this time, the body processor 132 may receive a control signal corresponding to an operation control command input to the remote controller 4 through the second communication module 122 and control an electronic device, such as the locking device 101.

The first processor 130 may control the registration of the mobile device 2 for the digital key service.

When the digital key is received from the mobile device 2, the first processor 130 may store information on the received digital key. At this time, the first processor 130 may store the identification information of the mobile device 2, the authentication information of the mobile device, and the vehicle control right information. The first processor 130 may control an operation of at least one electronic device in response to an operation control command of the at least one electronic device of the mobile device 2 received in the first communicator 120. The at least one electronic device may include a locking device, a heating wire, an air conditioner, and a power device and may further include a lamp, a side mirror, a ventilation device, and the like.

For example, the first processor 130 may control the locking device 101 to unlock the door in response to the unlock command of the mobile device 2 received in the first communicator 120 and control the locking device 101 to lock the door in response to the lock command of the mobile device 2 received in the first communicator 120. The first processor 130 may control the power device 104 of the vehicle in response to the start ON command of the mobile device 2 received in the first communicator 120 and control the power device 104 of the vehicle in response to the start OFF command of the mobile device 2 received in the first communicator 120. As shown in FIG. 2, the authentication processor 131 of the first processor 130 may communicate with the mobile device 2 through the first communication module 121. At this time, the authentication processor 131 may perform user authentication based on the digital key of the mobile device 2 received through the first communication module 121, transmit the authentication success information to the body processor 132 through the third communication module 123 when authentication is successful, and transmit the authentication failure information to the body processor 132 through the third communication module 123 when the authentication fails.

Upon successful authentication with the mobile device 2, the body processor 132 of the first processor 130 may receive a control signal corresponding to the operation control command input to the mobile device 2 through the first communication module 121 and control the operation of the electronic device, such as the locking device 101, based on the received control signal.

In addition, upon successful authentication with the mobile device 2, the body processor 132 of the first processor 130 may also receive the control signal of the mobile device 2 through the first and third communication modules 121 and 123 and the authentication processor 131.

When receiving the digital key and the operation control command of any one electronic device from the shared mobile device to which the right to pay through the car pay service is given, the first processor 130 may control the operation of any one electronic device based on the received digital key and operation control command of any one electronic device. The operation control of the electronic device of the vehicle through the shared mobile device may be the same as the control of the operation device of the electronic device of the vehicle through the owner mobile device.

When receiving an execution command of the application related to the car pay service, the first processor 130 may control the execution of the application, control the display of a subscription image corresponding to the execution of the application, and control the subscription to the car pay service based on the information input to the first input device 111.

The first processor 130 may transmit various information input to the first input device 111 to the server 3 as subscription information of the car pay service and transmit the information together with the vehicle identification information.

The first processor 130 may control the storing of payment setting information in response to the completion of the subscription.

The first processor 130 may display input request information of the password for user authentication and control the storing of the password input to the first input device when the user subscribes to the car pay service.

The first processor 130 may control an output of link authentication request information with the mobile device when the user subscribes to the car pay service.

When receiving the link authentication information for the car pay service from the mobile device 2, the first processor 130 may control the storing of the received link authentication information.

The first processor 130 may store the identification information of the mobile device and the authentication information of the mobile device for linking with the car pay service.

The first processor 130 recognizes the current position based on the position information received by the position receiver (not shown) and determines whether the recognized current position is a predetermined position.

The predetermined position is a position where the car pay service is performed and may include a gas station, a charging station, a car wash, a parking lot, a drive-through restaurant (e.g., a cafe or fast food restaurant), a toll gate, and the like.

When it is determined that the current position is the predetermined position, the first processor 130 may control the execution of the car pay service.

When receiving the payment request information at the predetermined position, the first processor 130 may determine whether the digital key is present inside the vehicle. Here, the determination of whether the digital key is present may include determining whether the mobile device 2 in which the digital key is stored is present.

The first processor 130 may determine whether the mobile device is present by performing the encrypted communication between the vehicle 1 and the mobile device 2 and performing the encrypted communication through a communication channel with guaranteed security.

The first processor 130 may determine whether the car pay service is set in the mobile device 2 when it is determined that the digital key is present and transmit the payment request information to the mobile device 2 when it is determined that the car pay service is set in the mobile device 2.

The first processor 130 proceeds with the payment when receiving the authentication success information from the mobile device 2 and controls the output of the authentication failure information when receiving the authentication failure information from the mobile device 2.

When receiving the authentication failure information, the first processor 130 may receive the authentication failure information together with authentication failure cause information and control at least one of the first display and the first sound output device to output the authentication failure cause information together.

When receiving payment limit excess information from the mobile device 2, the first processor 130 may control at least one of the first display and the first sound output device to output the received payment limit excess information. Here, a payment limit excess may be a maximum payment amount excess per day, a maximum payment amount excess per transaction, or a maximum number of transaction excess per day.

When receiving the authentication failure information or the payment limit excess information, the first processor 130 may also control the output of guide information inquiring whether to input the password for user authentication.

When receiving the authentication failure information or the payment limit excess information, the first processor 130 may also control the output of guide information requesting the input of the password or the pattern for user authentication.

When receiving input approval information of the password or the pattern through the first input device 111, the first processor 130 may control the display of a password image or an image for inputting the pattern.

The first processor 130 may compare the password received through the first input device 111 with a pre-stored password to determine whether the password received in the first input device 111 is the same as the pre-stored password, proceed with the payment when it is determined that the password received in the input device is the same as the pre-stored password, and control the output of a password error message when it is determined that the password received in the first input device 111 is different from the pre-stored password.

When it is determined that the password received in the first input device 111 is different from the pre-stored password, the first processor 130 may also control the output of guide information requesting a re-input of the password and also control the output of guide information requesting the direct payment using a physical card.

The first processor 130 may compare pattern information received through the first input device 111 with pre-stored pattern information to determine whether the pattern information received through the first input device 111 is the same as the pre-stored pattern information, proceed with the payment when it is determined that the pattern information received through the first input device 111 is the same as the pre-stored pattern information, and control an output of a pattern error message when it is determined that the pattern information received through the first input device 111 is different from the pre-stored pattern information.

When receiving the authentication failure information or the payment limit excess information, the first processor 130 may also recognize a user based on the user information received through the first information input device 114 and user recognition information stored in a first memory 130a and determine whether the recognized user is a pre-registered user.

When it is determined that the recognized user is the pre-registered user, the first processor 130 may also proceed with the payment.

When it is determined that the password received in the first input device 111 is the same as the pre-stored password and the user information received through the first information input device is the same as the pre-stored user recognition information of the user, the first processor 130 may also proceed with the payment.

The user recognition information stored in the first memory may include the user's facial information, voice information, fingerprint information, vein information, iris information, and the like.

The first processor 130 may confirm at least one of the position information of the side mirror and the position information of the seat input by the first input device 111 and recognize the user based on the confirmed at least one information and the information stored in the first memory.

The first processor 130 may also recognize the user through the communication with the mobile device.

The first processor 130 may determine whether the user boards and drops off the vehicle based on whether the door is opened or whether the user of the seat is detected and control the suspension of the payment when it is determined that the user has dropped off the vehicle.

When it is determined that the car pay service is in the manual payment mode, the first processor 130 may control the payment process when receiving the authentication success information from the mobile device.

When it is determined that the car pay service is in the automatic payment mode, the first processor 130 may perform the encrypted communication between the vehicle 1, the remote controller 4, and the mobile device and perform the encrypted communication through the communication channel with guaranteed security to perform the user authentication, proceed with the payment when the user authentication succeeds, and control the output of the payment failure information when user authentication fails.

Therefore, it is possible to perform the user authentication without the user action for user authentication, thereby improving user convenience.

When receiving the identification information and request information of the car pay service of another mobile device from another mobile device, the first processor 130 determines whether sharing is available based on the identification information and request information of the car pay service of another mobile device, transmits the approval information or rejection information of the car pay service to another mobile device when it is determined that the sharing is available, and transmits the payment setting information together.

When receiving the identification information and request information of the car pay service of another mobile device from another mobile device, the first processor 130 may control the display of the identification information and request information of the car pay service of another mobile device.

The first processor 130 may approve the right to use the car pay service for another mobile device when receiving the approval command through the first input device, and reject the right to use the car pay service when receiving the rejection command through the first input device.

When transmitting the approval information of the car pay service, the first processor 130 may also transmit the digital key to control the vehicle to another mobile device.

The first processor 130 may also transmit the approval information of the car pay service for another mobile device to the mobile device (which is the owner mobile device).

The first memory 130a may store the vehicle identification information and the user identification information.

The identification information of the vehicle 1 may include a vehicle type, model, identification information (license plate), power generation method (e.g., hybrid electric, electric, internal combustion engine, or hydrogen), transmission type, and the like of the vehicle.

The user identification information may include at least one of a user name, a user's date of birth, a user's social security number, a user gender, a user's phone number, a user's home address, a user's company address, a user's driver's license information, and a user's email address.

The first memory 130a may store the identification information of the mobile device performing the digital key service, the authentication information of the mobile device, and the digital key.

The first memory 130a may store the identification information, payment setting information, and password for user authentication of a mobile device for performing the car pay service.

When a plurality of users are present, the first memory 130a may store user identification information, identification information of the mobile device, payment setting information, and a password for each user.

Here, the payment setting information may include card information and account information.

The card information may include at least one of a card company, a card number, a card expiration date, a card password, and a security code (e.g., CVC).

The account information may include a bank name, an account number, an account password, and an account holder name.

The identification information of the mobile device is a unique identification information of the mobile device and includes at least one of a phone number of the mobile device, a Wi-Fi MAC address of the mobile device, a serial number of the mobile device, and an International mobile equipment identity (IMEI).

The identification information of the mobile device 2 may be a Bluetooth identification information (BTID).

The first memory 130a may also store information on a maximum payment amount per day, a maximum payment amount per transaction, and a maximum number of payments per day.

The first memory 130a may store a user's facial information, fingerprint information, iris information, voice information, vein information, and pattern information for user recognition and user authentication. When a plurality of users are present, the first memory 130a may store facial information, fingerprint information, iris information, voice information, vein information, and pattern information matching the user identification information for each user.

The first memory 130a may store position information of the side mirror and seat position information for each user.

The first memory 130a may further store the identification information of the remote controller.

The first memory 130a may be implemented as at least one of nonvolatile memory devices, such as a cache, a read only memory (ROM), a programmable ROM (PROM), an erasable programmable ROM (EPROM), an electrically erasable programmable ROM (EEPROM), and a flash memory, volatile memory devices, such as a random access memory (RAM), and storage media such as a hard disk drive (HDD) and a compact disc read-only memory (CD-ROM), but the present disclosure is not limited thereto.

The first memory 130a may be a memory implemented as a separate chip from the processor described above in connection with the processor 130 and may also be implemented as a single chip with the processor.

At least one component may be added or deleted depending on the performance of the components of the vehicle shown in FIGS. 1 and 2. In addition, it will be readily understood by those skilled in the art that the mutual positions of the components may be changed depending on the performance or structure of the system.

Meanwhile, each component shown in FIGS. 1 and 2 refers to software and/or hardware components, such as a field programmable gate array (FPGA) and an application specific integrated circuit (ASIC).

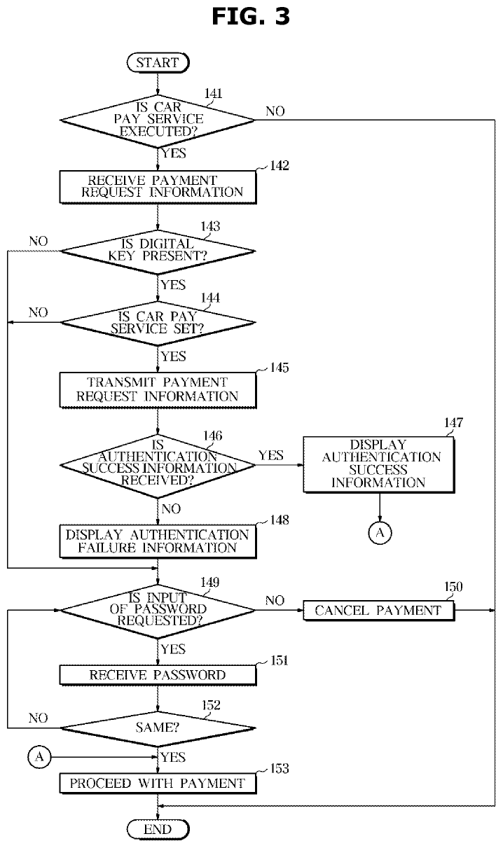

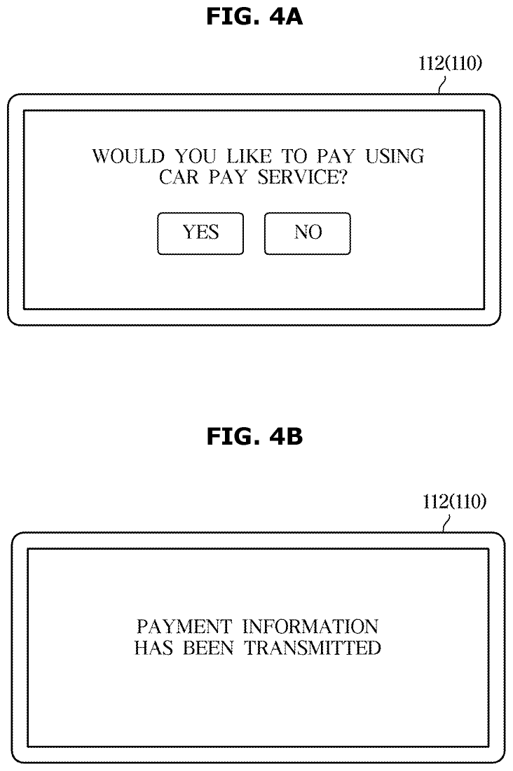

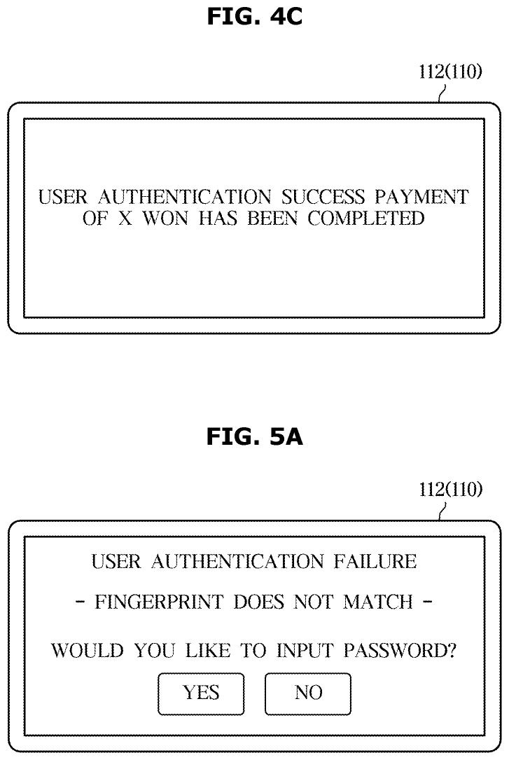

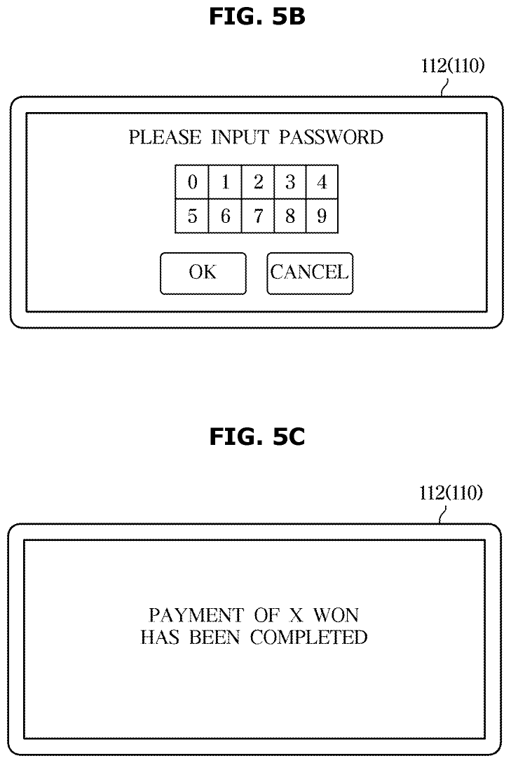

FIG. 3 is a control flowchart of a vehicle according to one embodiment and will be described with reference to FIGS. 4A, 4B, 4C, 5A, 5B, and 5C.

FIGS. 4A, 4B, 4C, 5A, 5B, and 5C are exemplary views of guide information displayed on the first display when the car pay service is performed in the vehicle according to one embodiment.

The vehicle 1 recognizes the current position based on position information received from the position receiver (not shown) and determines whether the recognized current position is the predetermined position.

The predetermined position is a position where the car pay service is performed and may include a gas station, a charging station, a car wash, a parking lot, a drive-through restaurant (e.g., a cafe or fast food restaurant), a toll gate, and the like.

When it is determined that the current position is the predetermined position, the vehicle may control the execution of the car pay service.

As shown in FIG. 4A, the vehicle may display an image inquiring about the use of the car pay service through the first display 112 of the vehicle terminal 110. At this time, the vehicle may proceed with the payment through the car pay service when receiving approval information Y through the first input device and end the payment through the car pay service when receiving rejection information N through the first input device.

The vehicle may also receive the execution command of the car pay service through the first input device 111.

When the car pay service is running at 141, the vehicle may receive the payment request information from a terminal (not shown) provided at the predetermined position or the server 3 at 142.

When receiving the payment request information, the vehicle may determine whether the digital key is present in the vehicle at 143. Here, determining whether the digital key is present may include determining whether the mobile device 2 in which the digital key is stored is present.

When it is determined that the digital key is present, the vehicle 1 may determine whether the car pay service is set in the mobile device 2 at 144 and transmit the payment request information to the mobile device 2 when it is determined that the car pay service is set in the mobile device 2 at 145. Here, the payment request information may include a payment amount.

The vehicle 1 may display guide information requesting the user authentication through the mobile device 2. As shown in FIG. 4B, the vehicle may display the guide information requesting the user authentication as an image through the first display 112 of the vehicle terminal 110.

The vehicle may determine whether the authentication success information is received from the mobile device 2 at 146 and display the authentication success information through the first display 112 at 147 and proceed with the payment at 153 when it is determined that the authentication success information has been received from the mobile device.

As shown in FIG. 4C, the vehicle may display the user authentication success information and the payment completion information as images through the first display 112 of the vehicle terminal 110.

The vehicle may transmit the payment completion information, such as a payment amount, a payment date, a company name, a company phone number, and an approval number to the server 3 when proceeding with the payment.

When it is determined that the authentication failure information has been received from the mobile device 2, the vehicle may display the authentication failure information at 148 and output the authentication failure cause information together through the first display 112. For example, the vehicle may display fingerprint mismatch information, communication error information, or the like as the authentication failure cause information.

As shown in FIG. 5A, the vehicle may display the user authentication failure cause information through the first display 112 of the vehicle terminal 110.

The vehicle may receive non-payment information due to the payment limit excess from the mobile device.

When receiving the payment limit excess information from the mobile device 2, the vehicle may control at least one of the first display 112 and the first sound output device 113 to output the received payment limit excess information. Here, a payment limit excess may be the maximum payment amount excess per day, the maximum payment amount excess per transaction, or the maximum number of transaction excess per day.

When receiving the authentication failure information or the payment limit excess information, the vehicle may also control the output of the guide information inquiring whether to input the password for user authentication.

As shown in FIG. 5A, the vehicle may display the guide information inquiring whether to input the password and display a button image Y for receiving the approval information and a button image N for receiving the rejection information through the first display 112 of the vehicle terminal 110.

When receiving the authentication failure information or the payment limit excess information, the vehicle may also control the output of the guide information requesting the input of the password or the pattern for user authentication.

When receiving the approval information on the request for inputting the password or the pattern through the first input device 111 at 149, the vehicle may control the display of the image for inputting the password or the pattern.

As shown in FIG. 5B, the vehicle may display a password image to input the password and display the button image (“OK”) for receiving the password entry completion information and the button image (“Cancel”) for receiving password entry cancellation information.

The vehicle may proceed with the payment cancellation 150 when not receiving the approval information for the request for inputting the password or the pattern through the first input device 111. In other words, the vehicle may proceed with the payment cancellation 150 when receiving the rejection information for the request for inputting the password or the pattern through the first input device 111.

The vehicle may receive the password or the pattern through the first input device 111 in response to the approval of the request for inputting the password or the pattern at 151.

When the user authentication method is the password, the vehicle may compare the received password with the pre-stored password to determine whether the password received in the first input device 111 is the same as the pre-stored password at 152, proceed with the payment at 153 when it is determined that the password received in the first input device 111 is the same as the pre-stored password, and control the output of the password error message when it is determined that the password received in the first input device 111 is different from the pre-stored password.

When it is determined that the password received in the first input device 111 is different from the pre-stored password, the vehicle may also control the output of the guide information requesting a re-input of the password and also control the output of the guide information requesting the direct payment using the physical card.

When the user authentication method is the pattern, the vehicle may compare the pattern information received through the first input device 111 with the pre-stored pattern information to determine whether the pattern information received through the first input device 111 is the same as the pre-stored pattern information, proceed with the payment when it is determined that the pattern information received through the first input device 111 is the same as the pre-stored pattern information, and control the output of the pattern error message when it is determined that the pattern information received through the first input device 111 is different from the pre-stored pattern information.

As shown in FIG. 5C, the vehicle may display the payment completion information through the first display 112 of the vehicle terminal 110.

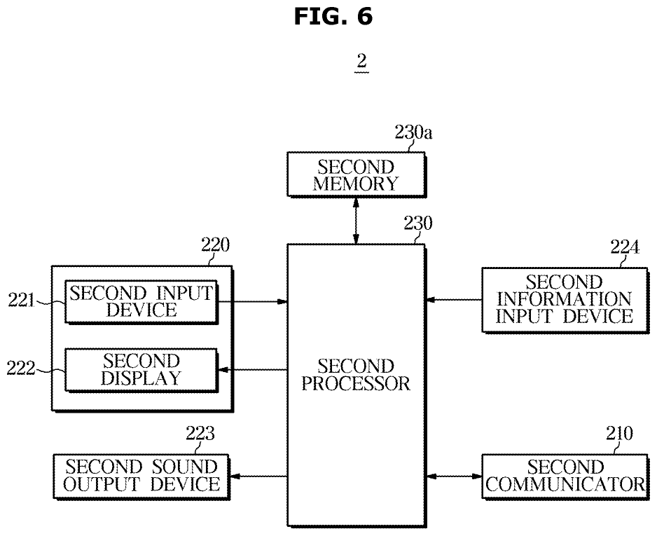

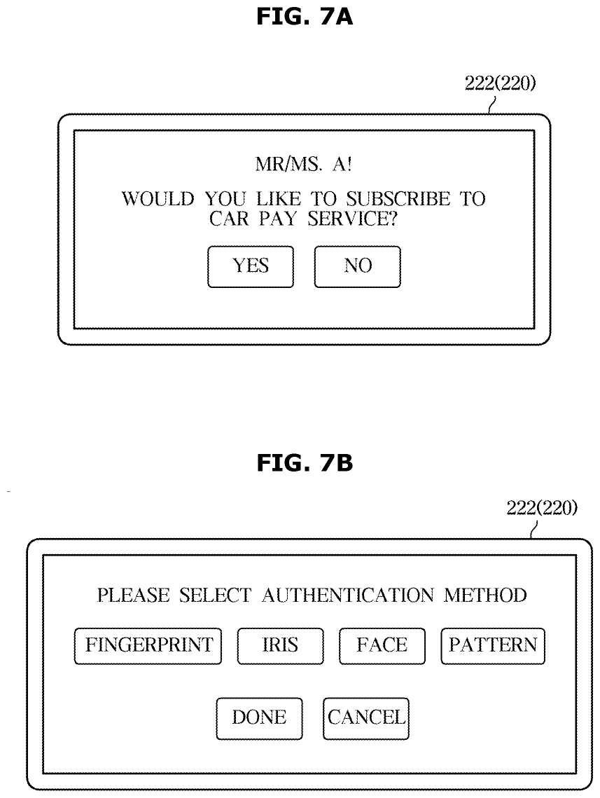

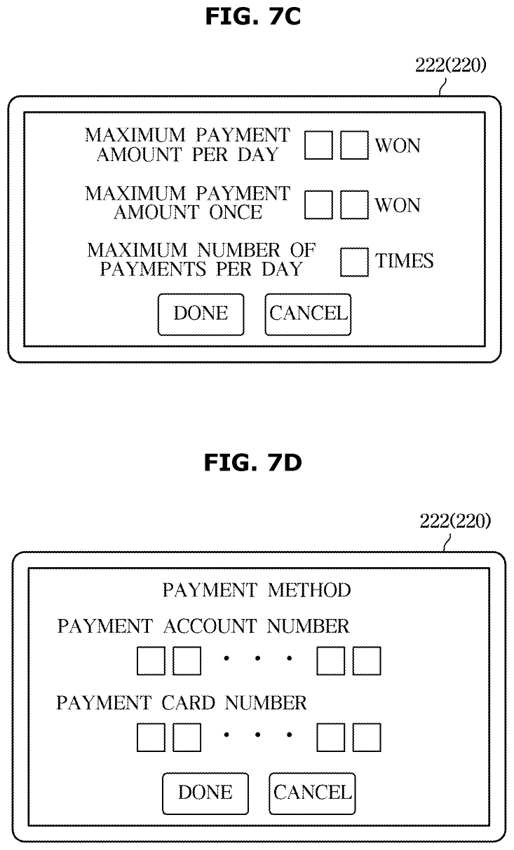

FIG. 6 is a control configuration diagram of a mobile device communicating with a vehicle according to one embodiment and will be described with reference to FIGS. 7A, 7B, 7C, and 7D.

FIGS. 7A, 7B, 7C, and 7D are exemplary views of guide information displayed on a second display when payment setting information of the car pay service is set in the mobile device according to one embodiment.

The mobile device 2 includes a second communicator 210, a user interface 220, a second sound output device 223, a second information input device 224, a second processor 230, and a second memory 230a.

In order to differentiate from the components of the vehicle, the second is given to the components of the mobile device.

The main mobile device of the first user (i.e., the owner) will be described.

The second communicator 210 may include one or more components configured to enable the communication between the external device and the internal components of the mobile device 2, and include, for example, at least one of a short-range communication module, a wired communication module, and a wireless communication module.

The short-range communication module, the wired communication module, and the wireless communication module of the mobile device may be the same as the short-range communication module, the wired communication module, and the wireless communication module of the vehicle.

The external device may include the vehicle and the server.

The second communicator 210 is a communication module for performing communication with the vehicle 1, and uses any one or two or more of a BLU module, a UWB module, and an NFC module.

The user interface 220 may include a second input device 221 and a second display 222. The second input device 221 may be provided as at least one of a jog dial type, a button type, and a touch pad type.

The second input device 221 may include a graphical user interface (GUI), such as a touch pad, that is, a software device. The touch pad may be implemented as a TSP to form a layered structure with a display panel of the second display 222.

The second input device 221 receives a user input.

The second input device 221 may receive an operation command for at least one function which may be performed by the mobile device. The second input device 221 may receive an execution command and an end command of an application installed in the mobile device and receive various information on the application.

The second input device 221 may receive an execution command of the digital key service and receive user authentication information for the car pay service.

The second input device 221 may receive a user registration command for the car pay service and receive a user deletion command for deleting some of the registered users.

The second input device 221 is subscription information for user registration of the car pay service and may also receive vehicle identification information, user identification information, card information, and account information.

The user identification information may include at least one of a user name, a user's date of birth, a user's social security number, a user's gender, a user's phone number, a user's home address, a user's company address, a user's driver's license information, and a user's email address.

The card information may include at least one of a card company, a card number, a card expiration date, a card password, and a security code (e.g., CVC).

The second input device 221 may also receive any one of a manual payment mode and an automatic payment mode when the car pay service and the digital key are linked.

The second input device 221 may receive identification information of another mobile device requesting the sharing of the car pay service and receive an approval or cancellation command for sharing.

The second display 222 may display a subscription image for user registration of the digital key service and user registration of the car pay service.

The second display 222 may display a progress image of the digital key service in response to the execution of the digital key service and display vehicle control right information which may be controlled by the user.

The second display 222 may display the progress image of the car pay service in response to the execution of the car pay service, display authentication success information and authentication failure information, display payment setting information set by the user, and display the authentication success information and the authentication failure information as images.

The second display 222 may display the identification information of another mobile device requesting the sharing of the car pay service and display approval information of the car pay service for approval completion or approval rejection.

The second sound output device 223 may output information on various functions performed by the mobile device 2 as a sound.

The second sound output device 223 may output the progress information of the car pay service as a sound in response to the execution of the car pay service and output the payment completion information and the payment failure information as the sound. Here, the sound may be a voice.

The second information input device 224 may receive information for user authentication. Here, the information for user authentication may include at least one of fingerprint information, facial image information, vein information, voice information, and iris information.

The second information input device 224 may include a microphone configured to receive a user's voice, a CCD or CMOS image sensor configured to acquire an image of the user's face or eyes, or a camera using infrared rays.

The second information input device 224 may include any one of a CCD camera and a CCD scanner configured to acquire fingerprint information, and include any one of a capacitive fingerprint sensor configured to detect a difference in capacitance according to a curvature of a fingerprint, an optical fingerprint sensor configured to detect the curvature of the fingerprint according to the shadow of reflected light, and an ultrasonic fingerprint sensor configured to detect minute features of a skin epidermal layer.

The second information input device 224 may include an infrared camera configured to acquire vein information. Here, the infrared camera may use infrared rays close to visible rays.

The information for user authentication may further include at least one of pattern information and password information. In this case, the information for user recognition may be received through the second input device 221.

The second processor 230 may proceed with the subscription to the car pay service through the digital key service, set payment setting information through the car pay service, and change the set payment setting information.

To execute the digital key service, the second processor 230 may execute an application related to the digital key service.

The second processor 230 may control a subscription image of the car pay service to be displayed when the user subscribes to the car pay service through the digital key service and proceed with the subscription to the car pay service based on the information received through the second input device.

As shown in FIG. 7A, when the digital key service is executed, the second processor 230 may control a subscription proposal image of the car pay service through the second display of the user interface.

The second processor 230 may receive a subscription command of the car pay service through the second input device 221.

When receiving approval information on the subscription proposal of the pay service through the second input device 221, the second processor 230 may control the output of the guide information requesting the selection of an authentication method to perform user authentication upon payment using the car pay service.

As shown in FIG. 7B, the second processor 230 may control authentication methods which may be performed by the mobile device to be displayed through the second display of the user interface.

The second processor 230 may control the operation of the second information input device 224 based on the authentication method selected by the user and store the user information received through the second information input device 224 as user authentication information.

For example, when the authentication method selected by the user is a fingerprint, the second processor 230 may store the user's fingerprint information received through the second information input device 224 as the user authentication information.

The second processor 230 may request the setting of the payment setting information and store the payment setting information based on the information input to the second input device.

As shown in FIG. 7C, the second processor 230 may control the second display to display guide information requesting the input of the maximum payment amount per day, the maximum payment amount per transaction, and the maximum number of transactions per day. In addition, the second processor 230 may set the maximum payment amount per day, the maximum payment amount once, and the maximum number of payments per day based on the information input to the second input device. In addition, the second processor 230 may further set the maximum payment amount for one month and the maximum number of payments for one month.

As shown in FIG. 7D, the second processor 230 may control the output of the guide information requesting the input of payment target information for which payment is performed through the second display 222.

The second processor 230 may transmit payment setting information to the server 3.

When receiving a communication attempt signal from the vehicle, the second processor 230 may confirm identification information of the vehicle transmitting the communication attempt signal and transmit a response signal to the vehicle when it is determined that the vehicle identification information is the same as the pre-stored vehicle identification information. Here, the communication attempt signal of the vehicle is a signal transmitted from the vehicle to determine whether the mobile device is present in the vehicle and may include an authentication request signal.

When receiving subscription confirmation request information for the car pay service from the vehicle, the second processor 230 may confirm whether to subscribe to the car pay service and transmit a response signal corresponding to the confirmed subscription to the car pay service to the vehicle. In other words, the second processor 230 may transmit the subscription information of the car pay service to the vehicle when the subscription to the car pay service is completed and transmit the non-subscription information of the car pay service to the vehicle when the car pay service is not subscribed.

When receiving the payment request information from the vehicle, the second processor 230 may display the received payment request information and also display the guide information requesting the user authentication.

The second processor 230 may perform the user authentication by comparing the user authentication information received through the second information input device with the user authentication information stored in the second memory.

The second processor 230 determines that the authentication has succeeded when the user authentication information received through the second information input device matches the user authentication information stored in the second memory and determines that authentication has failed when the user authentication information received through the second information input device does not match the user authentication information stored in the second memory.

When it is determined that the authentication has failed, the second processor 230 may transmit the authentication failure information to the vehicle and transmit the authentication failure cause information to the vehicle together.

When it is determined that the authentication has succeeded, the second processor 230 may determine whether the payment is available based on the received payment request information and the preset payment setting information and transmit the authentication success information and payment availability information to the vehicle and the server when it is determined that the payment is available.

When it is determined that the payment is not available, the second processor 230 may transmit non-payment information to the vehicle and the server.

For example, the second processor 230 may confirm the current number of payments based on the received payment request information, confirm the maximum number of payments per day based on the set payment setting information, and determine that the payment is not available when the current number of payments exceeds the maximum number of payments per day.

The second processor 230 may confirm the payment amount based on the received payment setting information when the current number of payments is smaller than the maximum number of payments per day, confirm the maximum payment amount once based on the payment setting information, and determine that the payment is not available when the confirmed payment amount exceeds the maximum payment amount once.

The second processor 230 may determine whether the amount paid for one day exceeds the maximum payment amount per day when the current number of payments is smaller than the maximum number of payments per day and the confirmed current payment amount is smaller than the maximum payment amount once and determine that the payment is not available when it is determined that the amount paid for one day exceeds the maximum payment amount per day.

The second processor 230 may determine that the payment is available when the current number of payments is smaller than the maximum number of payments per day, the confirmed current payment amount is smaller than the maximum payment amount once, and the amount paid for one day is smaller than the maximum payment amount per day.

The second processor 230 may transmit information on the number of payments and the payment amount to the server.

The second processor 230 may control the display of the user authentication request image in response to the receiving of the payment request information when the payment mode received in the second input device 221 is the manual payment mode, perform the encrypted communication with the vehicle and the remote controller in response to the receiving of the payment request information when the payment mode received in the second input device is the automatic payment mode, and control the transmission of the user authentication information upon encrypted communication.

When the mobile device is the owner's main mobile device, the second processor 230 controls the display of the identification information and request information of the car pay service of another mobile device when receiving the identification information and request information of the car pay service of another mobile device from another mobile device, and determines that the sharing of the car pay service with another mobile device is available, controls the transmission of the approval information of the car pay service to another mobile device, and controls the transmission of the payment setting information and the digital key when receiving the approval information through the second input device.

When the mobile device is the owner's main mobile device, the second processor 230 controls the transmission of the rejection information of the car pay service to another mobile device when receiving the rejection information through the second input device.

The second processor 230 may also transmit the approval information of the car pay service for another mobile device to the vehicle and the server.

When the mobile device is the shared mobile device and when the approval information of the car pay service, the payment setting information, and the digital key information are received from the owner's main mobile device, the second processor 230 may control the storing of the received approval information of the car pay service, payment setting information, and digital key information.

The shared mobile device may be the owner's auxiliary mobile device or the second user's mobile device.

When the mobile device is the shared mobile device, the second processor 230 may display the authentication method of the car pay service, control the operation of the second information input device 224 based on the authentication method selected by the user, and store the user information received through the second information input device 224 as the user authentication information.

When the mobile device is the shared mobile device and the payment request information is received from the vehicle, the second processor 230 may display the received payment request information and also display the guide information requesting the user authentication.

When the mobile device is the shared mobile device, since the configuration of the payment through the car pay service through the second processor 230 is the same as that of the owner's main mobile device, a description thereof will be omitted. The second memory 230a stores the identification information of the mobile device, the user identification information, and the vehicle identification information.

The second memory 230a may store the user's facial information, fingerprint information, vein information, iris information, pattern information, and password for user authentication.

The second memory 230a may store the digital key information and the payment setting information.

The payment setting information is information set by the user and may include the information on the maximum payment amount per day, the maximum payment amount per transaction, and the maximum number of transactions per day.

The second memory 230a may store card information and account information.

The second memory 230a may be implemented as at least on of non-volatile memory devices, such as a cache, a ROM, a PROM, an EPROM, an EEPROM, and a flash memory, volatile memory devices, such as a RAM, and storage media, such as a HDD and a CD-ROM, but the present disclosure is not limited thereto.

The second memory 230a may be a memory implemented as a separate chip from the processor described above in connection with the second processor 230 and may also be implemented as a single chip with the processor.

At least one component may be added or deleted depending on the performance of the components of the vehicle shown in FIG. 6. In addition, it will be readily understood by those skilled in the art that the mutual positions of the components may be changed depending on the performance or structure of the system.

Meanwhile, each component shown in FIG. 6 refers to software and/or hardware components, such as a FPGA and an ASIC.

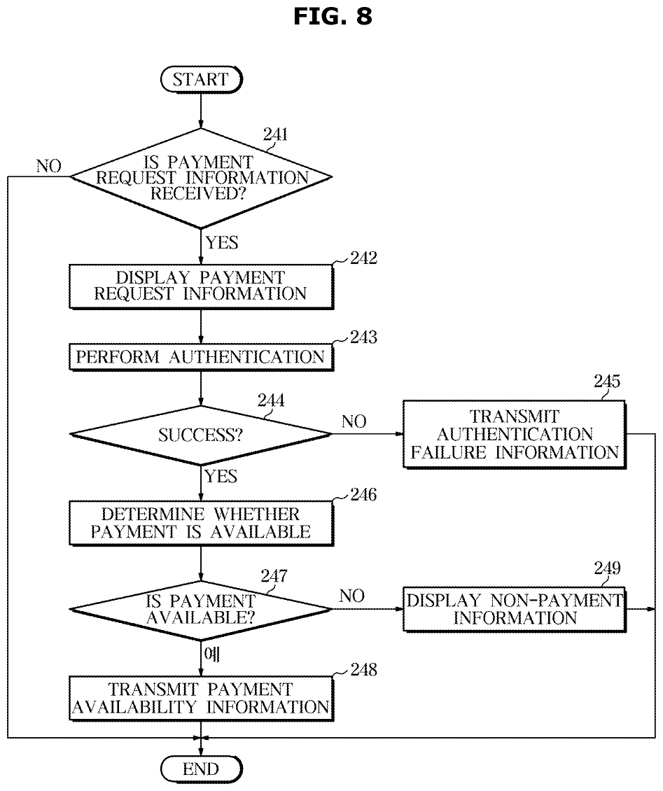

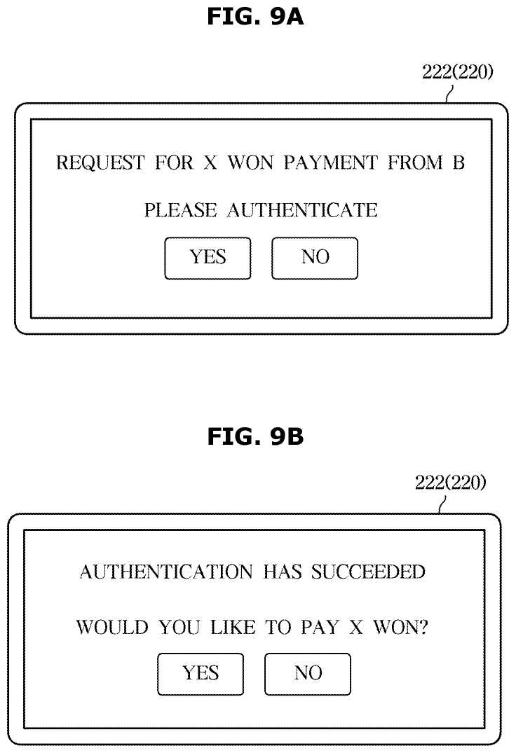

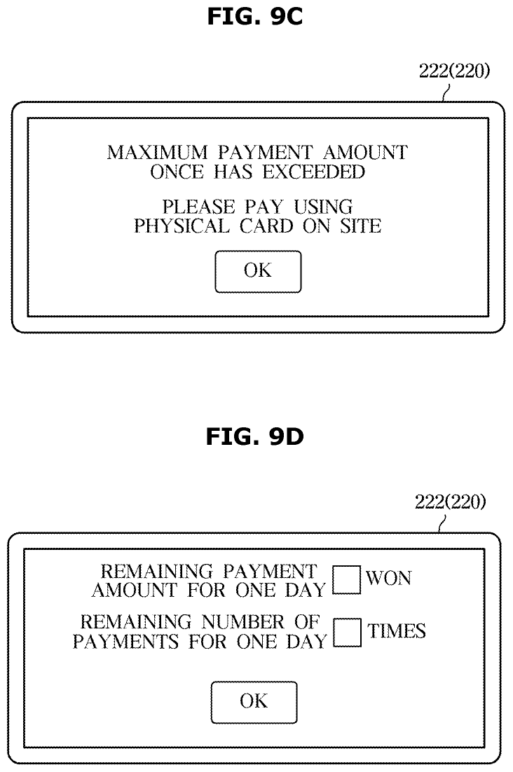

FIG. 8 is a control flowchart of the mobile device according to one embodiment and will be described with reference to FIGS. 9A, 9B, 9C, and 9D.

FIGS. 9A, 9B, 9C, and 9D are exemplary views of the guide information displayed on the second display when the car pay service is performed in the mobile device according to one embodiment.

The mobile device 2 may confirm identification information of the vehicle transmitting the communication attempt signal when receiving the communication attempt signal from the vehicle 1 and transmit the response signal to the vehicle when it is determined that the vehicle identification information is the same as the pre-stored vehicle identification information. Here, the communication attempt signal of the vehicle may be a signal transmitted from the vehicle to determine whether the mobile device is present in the vehicle. The communication attempt signal of the vehicle may include the authentication request signal.

When receiving the subscription confirmation request information of the car pay service from the vehicle 1, the mobile device 2 may confirm whether to subscribe to the car pay service and transmit the response signal corresponding to the confirmed subscription to the car pay service to the vehicle.

In other words, the mobile device 2 may transmit the subscription information of the car pay service to the vehicle 1 when the subscription to the car pay service is completed and transmit the non-subscription information of the car pay service to the vehicle 1 when the subscription to the car pay service is not completed.

When receiving the payment request information from the vehicle at 241, the mobile device 2 may display the received payment request information at 242 and display the guide information requesting the user authentication through the second display 222 of the user interface.

As shown in FIG. 9A, the mobile device 2 may display the received payment request information and the guide information requesting the user authentication and further display the button image for receiving the approval information and the button image for receiving the rejection information through the second display 222 of the user interface. Here, the received payment request information may include the company's name to pay the payment amount and the payment amount.

The mobile device 2 controls the activation of the second information input device when receiving the approval information for user authentication through the second input device 221.

The mobile device 2 may control the activation of the second information input device when the user authentication method is any one of a fingerprint, a face, an iris, and a vein. When the user authentication method is any one of the password and the pattern, the mobile device may control the deactivation of the second information input device 224 and receive the information for user authentication through the second input device 221.

The mobile device 2 may perform the user authentication (243) by comparing the user authentication information received through the second information input device 224 with the user authentication information stored in the second memory 230a.

For example, when a face is used for the user authentication method, the mobile device 2 may perform the user authentication by activating the second information input device 224 and acquiring a matching rate between the information based on the facial information received through the second information input device 224 and the facial information stored in the second memory 230a.

When a voice is used for the user authentication method, the mobile device 2 may perform the user authentication by activating the second information input device 224, requesting the user to speak, performing voice recognition on the voice received in the second information input device 224, and acquiring a matching rate between the information based on the recognized voice information and the voice information stored in the second memory 230a.

When an iris is used for the user authentication method, the mobile device may perform the user authentication by activating the second information input device 224 and acquiring a matching rate between the information based on the iris information received through the second information input device 224 and the iris information stored in the second memory 230a.

When a fingerprint is used for the user authentication method, the mobile device may perform the user authentication by activating the second information input device 224, recognizing the fingerprint received in the second information input device 224, and acquiring a matching rate between the information based on the recognized fingerprint information and the fingerprint information stored in the second memory.

When a pattern is used for the user authentication method, the mobile device may perform the user authentication by confirming positions of touch points received in the second input device 221, acquiring pattern information based on the confirmed position information of the touch points, and acquiring a matching rate between the information based on the acquired pattern information and the pattern information stored in the second memory.

When a password is used for the user authentication method, the mobile device may perform the user authentication by confirming positions of touch points received by the second input device 221, acquiring password information based on the confirmed position information of the touch points, and acquiring a matching rate between information based on the acquired password information and the password information stored in the second memory.

The mobile device 2 may determine that the authentication has succeeded when the matching rate between the user authentication information received through the second information input device 224 and the user authentication information stored in the second memory 230a is a reference matching rate or higher and determine that the authentication has failed when the matching rate between the user authentication information received through the second information input device 224 and the user authentication information stored in the second memory 230a is smaller than the reference matching rate.

When it is determined that the authentication has failed, the mobile device 2 may transmit the authentication failure information to the vehicle at 245 and also transmit the authentication failure cause information to the vehicle together.

When it is determined that the authentication has succeeded, the mobile device 2 determines whether the payment is available based on the received payment request information and the preset payment setting information at 246.

When it is determined that the authentication has succeeded, the mobile device 2 may also display the authentication success information and guide information inquiring about payment progress maintenance. As shown in FIG. 9B, the mobile device may display guide information on authentication success and payment inquiry through the second display of the user interface.

For example, the mobile device 2 may confirm the current number of transactions based on the received payment request information, confirm the maximum number of transactions per day based on the payment setting information, and determine that the payment is not available when the current number of payments exceeds the maximum number of payments per day.

The mobile device 2 may confirm the payment amount based on the received payment request information and confirm the maximum payment amount per transaction based on the payment setting information when the current number of payments is smaller than the maximum number of payments per day and determine that the payment is not available when the confirmed payment amount exceeds the maximum payment amount once.

The mobile device 2 may determine whether the payment amount for one day exceeds the maximum payment amount per day when the current number of payments is smaller than the maximum number of payments per day and the confirmed current payment amount is smaller than the maximum payment amount once and determine that the payment is not available when it is determined that the amount paid for one day exceeds the maximum payment amount per day.

The mobile device 2 may determine that the payment is available when the current number of payments is smaller than the maximum number of payments per day, the confirmed current payment amount is smaller than the maximum payment amount once, and the amount paid for one day is smaller than the maximum payment amount per day.

The mobile device may transmit the authentication success information and the payment availability information to the vehicle and the server at 248 when it is determined that the payment is available (at 247, display the non-payment information at 249 when it is determined that the payment is not available, and transmit the non-payment information to the vehicle and the server.

As shown in FIG. 9C, the mobile device may display information on a non-payment cause through the second display of the user interface.

As shown in FIG. 9D, when the user authentication is successful and it is determined that the payment is available, the mobile device 2 may also confirm the remaining payment amount for one day and the remaining number of payments for one day and display the confirmed remaining payment amount for one day and remaining number of payments for one day through the second display 222 of the user interface 220.

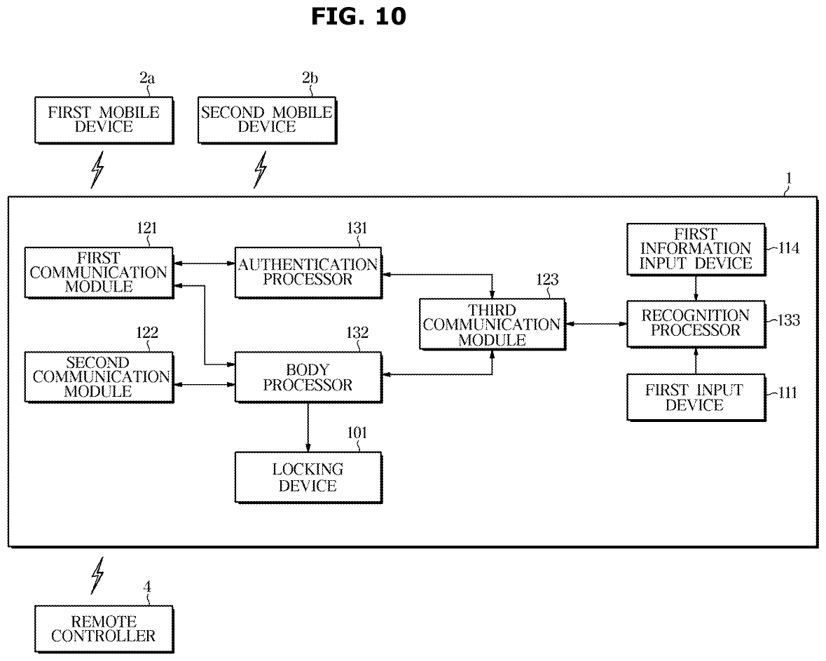

FIG. 10 is a detailed configuration diagram of a processor and a communicator of a vehicle according to another embodiment.

A first processor of the vehicle according to another embodiment may further include a recognition processor 133 for user recognition.

The vehicle according to another embodiment may perform the user authentication using the recognition processor 133 to determine a mobile device to perform a car pay service from among a plurality of mobile devices 2a and 2b when the plurality of mobile devices in which a digital key is stored are provided.

The recognition processor 133 may acquire user recognition information based on information received by at least one of a first information input device 114 and a first input device 111, determine whether the recognized user is a pre-registered user based on the acquired user recognition information and user recognition information stored in a memory, confirm identification information of the mobile device matching a user identification information of the recognized user when it is determined that the recognized user is the pre-registered user, and control the communication with the mobile device based on the confirmed identification information of the mobile device.

Since the user recognition based on the information received by at least one of the first information input device 114 and the first input device 111 is the same as that of the one embodiment, a description thereof will be omitted.

The recognition processor 133 may transmit the identification information of the mobile device confirmed through a third communication module 123 to the authentication processor.

The authentication processor 131 may communicate with the mobile device through a first communication module 121 based on the confirmed identification information of the mobile device and perform the car pay service through the first communication module 121.

When the user authentication by the mobile device fails, the vehicle according to another embodiment may also perform the user authentication based on the user recognition information in the recognition processor 133 and pre-stored user recognition information. In other words, when it is determined that the recognized user is the pre-registered user, the recognition processor 133 may determine that the user authentication has succeeded.

Meanwhile, the disclosed embodiments may be implemented in the form of a recording medium configured to store instructions executable by a computer. The instructions may be stored in the form of program code and may perform the operations of the disclosed embodiments by generating a program module when executed by a processor. The recording medium may be implemented as a computer-readable recording medium.

The computer-readable recording medium includes all types of recording media in which the instructions readable by the computer are stored. For example, there may be a ROM, a RAM, a magnetic tape, a magnetic disc, a flash memory, an optical data storage device, and the like.

According to the present disclosure, it is possible to safely and conveniently proceed with a payment in a vehicle and improve security in a user authentication process by linking a car pay service which can be performed in the vehicle with a digital key service which can be performed in a mobile device. In other words, according to the present disclosure, it is possible to secure stronger security than a password which can be exposed to others by performing the user authentication through the digital key service of the mobile device.

In addition, according to the present disclosure, it is possible to prevent others from using the car pay service by recognizing whether a user who pays through the car pay service is actually a registered user. In other words, according to the present disclosure, it is possible to prevent the use of the car pay service even when the vehicle is stolen.

In addition, according to the present disclosure, automatic payment is possible without a user authentication process through the mobile device by performing the user authentication through encrypted communication between the mobile device, a remote controller, and the vehicle when the automatic payment in the car pay service is set. Therefore, according to the present disclosure, it is possible to increase user convenience.

According to the present disclosure, it is possible to improve convenience by allowing the car pay service to be used through a shared mobile device.

In addition, it is possible to prevent the cost incurred by adding and manufacturing hardware because the user authentication can be implemented by only changing software without changing the hardware for user authentication for the car pay service.

According to the present disclosure, it is possible to improve the quality and merchantability of the vehicle, furthermore, improve the user convenience and the safety of the vehicle, and secure the competitiveness of a product.

The disclosed embodiments have been described with reference to the accompanying drawings as described above. Those skilled in the art to which the present disclosure pertains will understand that the present disclosure may be carried out in other forms than the disclosed embodiments without changing the technical spirit or essential features of the present disclosure. The disclosed embodiments are illustrative and should not be construed as being restrictive.

1. A vehicle comprising:
a display;
a communicator configured to communicate with a mobile device; and
a processor configured to transmit an authentication request signal to the mobile device when performing a car payment service, to proceed with a payment when authentication success information is received from the mobile device, and to control the display to output authentication failure information and cancel the payment when the authentication failure information is received from the mobile device.

2. The vehicle of claim 1, wherein the mobile device is configured to perform a digital key service for controlling an operation of at least one of a plurality of electronic devices provided in the vehicle; and
wherein the processor is configured to control interworking with the digital key service when performing the car payment service.

3. The vehicle of claim 2, wherein the processor is further configured to determine whether the mobile device is present in the vehicle before transmitting the authentication request signal.

4. The vehicle of claim 3, further comprising an input device,
wherein, when it is determined that the mobile device is not present in the vehicle, the processor is configured to control the display to display an image for inputting a password or a pattern, to perform user authentication based on the password or the pattern received through the input device, and to proceed with the payment when the user authentication is successful.

5. The vehicle of claim 2, wherein the processor is further configured to determine whether to subscribe to the car payment service through the mobile device before transmitting the authentication request signal.

6. The vehicle of claim 5, further comprising an input device,
wherein, when the authentication failure information is received from the mobile device, the processor is configured to control the display to display an image for inputting a password or a pattern, to perform user authentication based on the password or the pattern received through the input device, and to proceed with the payment when the user authentication is successful.

7. The vehicle of claim 1, wherein the processor is configured to control execution of the car payment service when a current position is a predetermined position.

8. The vehicle of claim 1, further comprising an input device,
wherein, when the authentication failure information is received from the mobile device, the processor is configured to control the display to display an image for inputting a password or a pattern, to perform user authentication based on the password or the pattern received through the input device, and to proceed with the payment when the user authentication is successful.

9. The vehicle of claim 1, wherein, when non-payment information is received from the mobile device, the processor is configured to control the display to display the received non-payment information.

10. The vehicle of claim 1, wherein the communicator includes at least one of Bluetooth communication, ultra-wide band communication, near-field communication (NFC), low-frequency communication, and high-frequency communication.

11. A mobile device comprising:
a display;
an information input device configured to receive user authentication information;
a memory configured to store pre-registered user authentication information;
a communicator configured to perform communication with a vehicle; and
a processor configured to control the display to display guide information requesting user authentication when an authentication request signal is received from the vehicle, to perform the user authentication based on the user authentication information received through the information input device and the pre-registered user authentication information, and to transmit authentication success information or authentication failure information corresponding to a result of the user authentication to the vehicle.

12. The mobile device of claim 11, wherein the processor is configured to control execution of a car payment service in response to the receiving of the authentication request signal, and to transmit the authentication success information or the authentication failure information to the vehicle during the execution of the car payment service.

13. The mobile device of claim 12, wherein the processor is configured to control the display to output guide information requesting an input of payment setting information to be used for the car payment service when a subscription command of the car payment service is received through the input device, and to store information received through the input device as the payment setting information of the car payment service.

14. The mobile device of claim 13, wherein the set payment setting information of the car payment service includes at least one of card information and account information, and further includes a maximum payment amount per day, a maximum payment amount per transaction, and a maximum number of transactions per day.

15. The mobile device of claim 14, wherein, when the result of the user authentication is authentication success, the processor is configured to determine whether a payment is available based on payment request information received from the vehicle and the set payment setting information of the car payment service, and to transmit the authentication success information and payment availability information to the vehicle when it is determined that the payment is available;
wherein the processor is further configured to transmit non-payment information to the vehicle when it is determined that the payment is not available; and
wherein the processor is further configured to transmit information on a remaining payment amount and a remaining number of transactions to the vehicle when it is determined that the payment is available.

16. The mobile device of claim 13, wherein the processor is configured to control subscription information of the car payment service, which corresponds to whether to subscribe to the car payment service, to be transmitted to the vehicle when subscription inquiry information of the car payment service is received from the vehicle.

17. The mobile device of claim 11, wherein the processor is configured to perform a digital key service for controlling an operation of at least one of a plurality of electronic devices provided in the vehicle, and to control interlocking with the digital key service when performing a car payment service.

18. The mobile device of claim 11, wherein the processor is configured to perform the user authentication based on password information or pattern information received through the information input device and pre-registered password information or pattern information.

19. The mobile device of claim 11, wherein the processor is configured to control the display to display identification information of another mobile device when request information of the car payment service is received from the another mobile device, and to transmit approval information, payment information, and a digital key of the car payment service to the another mobile device when an approval command is received through the information input device.

20. The mobile device of claim 11, wherein the processor is configured to share the car payment service when a digital key is received from another mobile device, and wherein the processor is further configured to perform a same function as that of the received digital key when the digital key is received from another mobile device.
